(19) United States
(12) Patent Application Publication
(10) Pub. No.: US 2026/0079050 A1
(43) Pub. Date: Mar. 19, 2026

(54) ANALOG DUAL-COMB SENSING WITH CONTINUOUS-WAVE LOCAL OSCILLATION

(71) Applicant: NEC Laboratories America, Inc., Princeton, NJ (US)

(72) Inventor: Jian FANG, PRINCETON, NJ (US)

(73) Assignee: NEC Laboratories America, Inc., Princeton, NJ (US)

(21) Appl. No.: 19/218,637

(22) Filed: May 27, 2025

Related U.S. Application Data
(60) Provisional application No. 63/652,327, filed on May 28, 2024.

(51) Int. Cl. G01J 3/26

(52) U.S. Cl. CPC G01J 3/26

(57) ABSTRACT

Disclosed are schemes for analog dual-comb sensing with a continuous-wave local oscillator that provides analog dual-comb sensing and overcome limitations of the prior art, analog DCS schemes. Operationally, one optical frequency comb (OFC) is intensity modulated by an analog RF comb generator (such as SRD, NLTL, etc.) while the other OFC is phase-modulated by another analog RF comb generator having a slightly different frequency spacing. The intensity-modulated OFC, (in narrow-pulse shape) is used as the “probe” to measure a medium under test, while the phase-modulated OFC (in continuous waves) is used as a “local oscillator” and beat with the “probe” comb and amplify the output. In the detection stage, our schemes take the advantage of polarization diversity coherent detection, eliminating fading that infirmed previous schemes due to the polarization drift and phase noises.

### CROSS REFERENCE TO RELATED APPLICATIONS

This application claims the benefit of United States Provisional Patent Application Ser. No. 63/652,327 filed May 28, 2024, the entire contents of which is incorporated by reference as if set forth at length herein.

### FIELD OF THE INVENTION

This application relates generally to frequency-comb spectroscopy. More particularly, it pertains to a scheme of analog dual-comb sensing with a continuous-wave local oscillator.

### BACKGROUND OF THE INVENTION

Frequency-comb spectroscopy, the subject of the Nobel Prize in physics 2005, has enabled a wide range of applications with respect to the measurement of atomic and molecular structures. Recently, dual-comb spectroscopy (DCS) techniques have revolutionized frequency-comb spectroscopy by providing frequency-comb spectroscopy with broadband spectral measurements exhibiting unprecedented resolution and rapid response.

DCS utilizes two frequency combs with slightly different repetition rates (the spacing between the comb teeth). When these two combs interact (heterodyne) on a photodetector, they generate a radio-frequency (RF) comb. This RF comb contains all the spectral information of the optical combs, but it's down-converted to much lower, easily detectable frequencies.

Dual-comb sensing exploits the interferograms between two coherent optical frequency combs (OFC) with slightly different spacings. Each set of optical frequency comb line pair generates a radiofrequency (RF) beat note, transforming the optical spectrum into the radio-frequency domain with a squeezing factor.

One key for achieving high-quality dual-comb spectroscopy and sensing is the generation of a pair of optical frequency combs with high-level mutual coherence. One of the widely used methods is to generate coherent optical-frequency comb pair “digitally,” i.e., utilize digital instruments to modulate programmed waveforms to the coherent laser light field through electro-optic modulators. Such method typically requires the instruments with high-speed digital-to-analog devices, such as high-end arbitrary waveform generators or random number generators, which drastically increase the cost, dimension, and complexity.

A cost-effective alternative is to generate the optical frequency combs with analog devices. Such method modulates the coherent light field with analog radio-frequency comb generators, such as step recovery diodes (SRDs) or nonlinear transmission lines (NLTLs). The analog RF comb generators, which are much more compact and cost-effective than the digital generators, can be driven and controlled with low-speed electronics, paving the way for the practical applications of dual-comb spectroscopy and sensing.

One limitation of analog RF comb generators such as SRDs is that the waveforms are transform-limited, i.e., the waveforms have the minimum possible duration for a given spectral bandwidth. Although transform-limited waveforms can mitigate the chromatic dispersion in optical transmission, there are a few drawbacks in dual-comb sensing. First, the OFCs created from analog RF comb generators are typically ultra-short pulses in time domain, which means that most of the energy is concentrated within a noticeably short time period. This leads to several detrimental issues including the nonlinear impairments and the modulation efficiency. At the detection stage, since both combs are transform-limited, a high peak power and short pulse duration pose significant challenges for photodetectors, including the high input peak power and low output powers.

### SUMMARY OF THE INVENTION

The above problems are solved, and an advance is made in the art according to aspects of the present disclosure directed to a scheme for analog dual-comb sensing with a continuous-wave local oscillator.

Our inventive schemes according to aspects of the present disclosure provide analog dual-comb sensing which overcome limitations of the prior art, analog DCS schemes.

According to aspects of the present disclosure, one optical frequency comb (OFC) is intensity modulated by an analog RF comb generator (such as SRD, NLTL, etc.) while the other OFC is phase-modulated by another analog RF comb generator having a slightly different frequency spacing. The intensity-modulated OFC, (in narrow-pulse shape) is used as the “probe” to measure a medium under test, while the phase-modulated OFC (in continuous waves) is used as a “local oscillator” and beat with the “probe”comb and amplify the output.

In the detection stage, our inventive schemes take the advantage of polarization diversity coherent detection, eliminating fading that infirmed previous schemes due to the polarization drift and phase noises.

Particularly inventive features of our systems and methods according to aspects of the present disclosure include the following.

Our inventive systems and methods generate two optical frequency combs using a pair of analog RF comb generators, specifically, one optical frequency comb is generated by intensity modulation and the other is generated through phase modulation.

Additionally, our inventive systems and methods detect the two optical frequency combs using a coherent receiver with phase diversity and/or polarization diversity, specifically, the intensity-modulated optical frequency comb is used as the probe while the phase-modulated optical frequency comb serves as the local oscillator.

Finally, our inventive systems and methods employ unique, flexible signal processing steps, including the engineering of multiple Nyquist bands and frequency filtering strategies.

As those skilled in the art will understand and appreciate, these and other inventive features and aspects of systems and methods according to the present disclosure advantageously resolve transform-limited issues that plague conventional, prior art schemes, mitigate nonlinear impairments, enhance the signal-to-noise ratio (SNR), and consequently improve overall performance of dual-comb sensing systems and methods.

### BRIEF DESCRIPTION OF THE DRAWING

FIG. 1 is a schematic flow diagrams showing an illustrative aspects of systems and methods according to aspects of the present disclosure with particularly distinguishing aspects shown in the right side of the diagram.

FIG. 2 is a schematic diagram showing illustrative optical frequency comp spectroscopy according to aspects of the present disclosure.

FIG. 3 is a schematic diagram showing illustrative dual-comb spectroscopy according to aspects of the present disclosure.

FIG. 4 is a schematic diagram showing an illustrative dual comb sensing scheme based on intensity modulation (IM scheme) according to aspects of the present invention.

FIG. 5 is a schematic diagram showing an illustrative dual comb sensing scheme based on phase modulation (PM scheme) according to aspects of the present disclosure.

FIG. 6 is a schematic diagram showing an illustrative dual comb sensing scheme according to aspects of the present invention.

FIG. 7A, FIG. 7B, FIG. 7C, FIG. 7D, FIG. 7E, and FIG. 7F show a series of dual comb interferograms at 0 (rad) phase with 1^{st} Nyquist band LPF according to aspects of the present disclosure.

FIG. 8A, FIG. 8B, FIG. 8C, FIG. 8D, FIG. 8E, and FIG. 8F show a series of dual comb interferograms at π/4 phase with 1^{st} Nyquist band LPF according to aspects of the present disclosure.

FIG. 9A, FIG. 9B, FIG. 9C, FIG. 9D, FIG. 9E, and FIG. 9F show a series of dual comb interferograms at π/2 phase with 1^{st} Nyquist band LPF according to aspects of the present disclosure.

FIG. 10A, FIG. 10B, FIG. 10C, FIG. 10D, FIG. 10E, and FIG. 10F show a series of dual comb interferograms at 0 (rad) phase with 2^{nd} Nyquist band LPF according to aspects of the present disclosure.

FIG. 11A, FIG. 11B, FIG. 11C, FIG. 11D, FIG. 11E, and FIG. 11F show a series of dual comb interferograms at π/4 phase with 2^{nd} Nyquist band LPF according to aspects of the present disclosure.

FIG. 12A, FIG. 12B, FIG. 12C, FIG. 12D, FIG. 12E, and FIG. 12F show a series of dual comb interferograms at π/2 phase with 2^{nd} Nyquist band LPF according to aspects of the present disclosure.

FIG. 13 is a schematic diagram in hierarchical format showing illustrative features of systems and methods according to aspects of the present disclosure.

FIG. 14 is a schematic diagram showing illustrative computer system in which aspects of systems and methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we again note that frequency-comb spectroscopy, honored as the Nobel Prize in physics 2005, has enabled a wide range of applications on the measurement of atomic and molecular structures. Recently, the dual-comb spectroscopy technology has revolutionized frequency-comb spectroscopy by providing broadband spectral measurements with unprecedented resolution and rapid response. Dual-comb sensing exploits the interferograms between two coherent optical frequency combs with slightly different spacings. The two coherent optical frequency combs (OFCs). Each set of optical frequency comb line pair generates a radiofrequency (RF) beat note, transforming the optical spectrum into the radio-frequency domain with a squeezing factor.

One key aspect of achieving high-quality dual-comb spectroscopy and sensing is the generation of a pair of optical frequency combs with high-level mutual coherence. One of the widely used methods is to generate coherent optical-frequency comb pair “digitally,” i.e., utilize digital instruments to modulate programmed waveforms to the coherent laser light field through electro-optic modulators. Such method typically requires the instruments with high-speed digital-to-analog devices, such as high-end arbitrary waveform generators or random number generator, which drastically increase the cost, dimension, and complexity.

A cost-effective alternative is to generate the optical frequency combs with analog devices. Such method modulate the coherent light field with analog radio-frequency comb generators, such as step recovery diodes (SRDs) or nonlinear transmission lines (NLTLs). The analog RF comb generators, which are much more compact and cost-effective than the digital generators, can be driven and controlled with low-speed electronics, paving the way for the practical applications of dual-comb spectroscopy and sensing.

One limitation of the analog RF comb generators such as SRDs is that the waveforms are transform-limited, i.e., the waveforms have the minimum possible duration for a given spectral bandwidth. Although transform-limited waveforms can mitigate the chromatic dispersion in optical transmission, there are a few drawbacks in dual-comb sensing. First, the OFCs created from analog RF comb generators are typically ultra-short pulses in time domain, which means that most of the energy is concentrated within a noticeably short time period. This leads to several detrimental issues including the nonlinear impairments and the modulation efficiency. At the detection stage, sine both of the combs are transform-limited, the high peak power and short pulse duration pose significant challenges to the photodetectors including the high input peak power and low output powers.

Our invention discloses a novel scheme of the analog dual-comb sensing which solves the limitations of the previous analog DCS schemes. In our scheme, one optical frequency comb (OFC) is intensity modulated by an analog RF comb generator (such as SRD, NLTL, etc.) while the other OFC is phase-modulated by another analog RF comb generator with a slightly difference frequency spacing. The intensity-modulated OFC, (in narrow-pulse shape) is used as the “probe” to measure the medium under test, while the phase-modulated OFC (in continuous waves) is served as the “local oscillator” to beat with the “probe” comb and amplify the output. In the detection stage, our scheme takes the advantage of the polarization diversity coherent detection, eliminating the fading in previous schemes due to the polarization drift and phase noises.

### Inventive Features in This Disclosure Include the Following

Our inventive systems and methods generate two optical frequency combs using a pair of analog RF comb generators, specifically, one optical frequency comb is generated by intensity modulation and the other is generated through phase modulation.

Additionally, our inventive systems and methods detect two optical frequency combs using a coherent receiver with phase diversity and/or polarization diversity, specifically, the intensity-modulated optical frequency comb is used as the probe while the phase-modulated optical frequency comb serves as the local oscillator.

Finally, our inventive systems and methods employ unique, flexible signal processing steps, including the engineering of multiple Nyquist bands and frequency filtering strategies.

These—and other—inventive features can resolve the transform-limited issues in the conventional schemes, mitigate the nonlinear impairments, enhance the signal-to-noise ratio (SNR), and therefore improve the performance of the dual-comb sensing systems

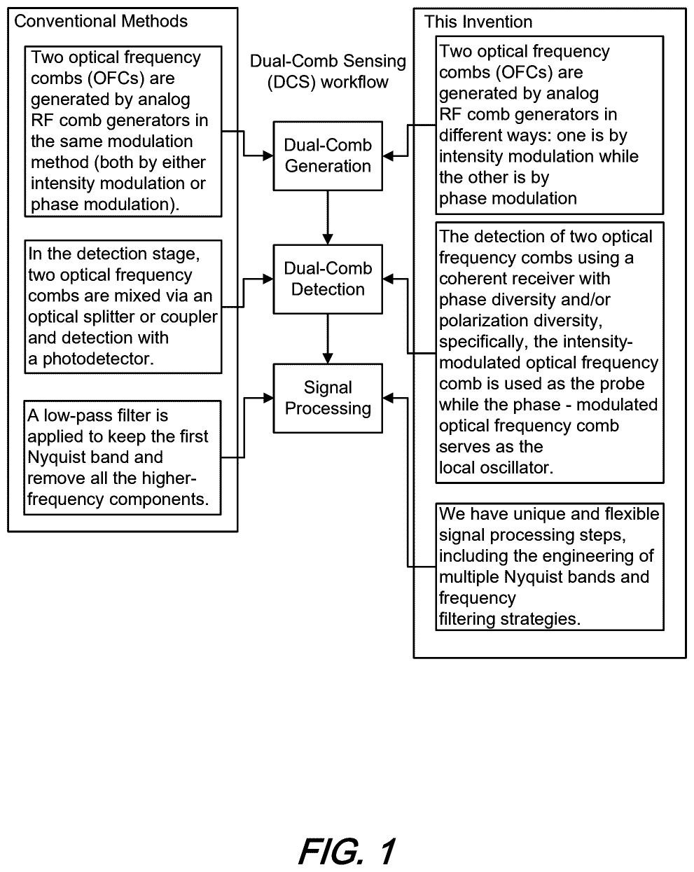

FIG. 1 is a schematic flow diagram showing illustrative aspects of systems and methods according to aspects of the present disclosure with particularly distinguishing aspects shown in the right side of the diagram.

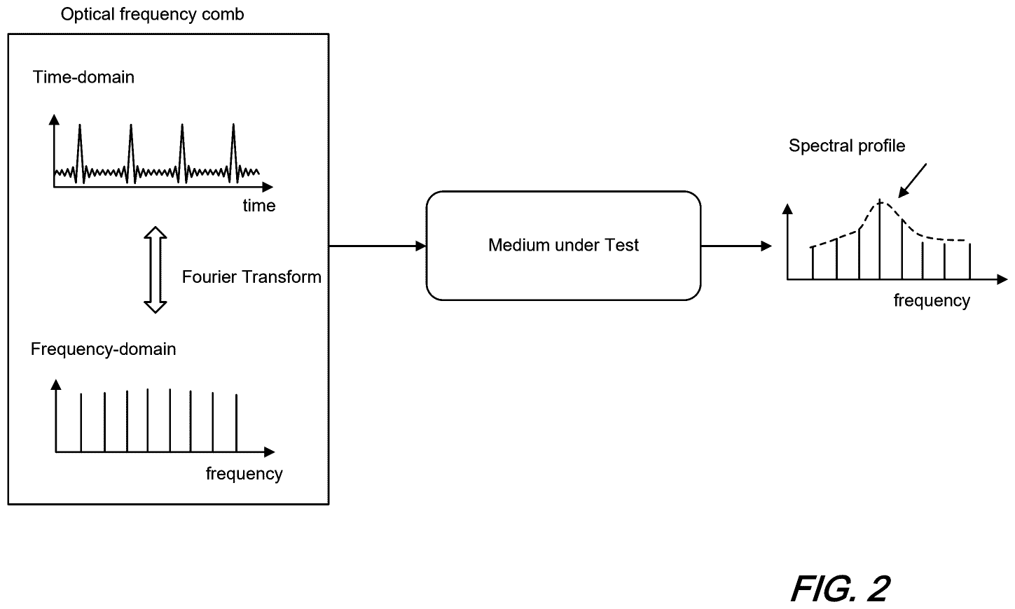

FIG. 2 is a schematic diagram showing illustrative optical frequency comp spectroscopy according to aspects of the present disclosure.

As is known in the art, optical frequency comb spectroscopy is a widely used, powerful spectroscopy technique. Instead of frequency scanning, optical frequency comb spectroscopy uses an optical frequency comb as a precious and accurate frequency reference to measure and analyze the spectral profile of various medium under test, as illustratively shown in FIG. 2.

The optical frequency comb serves as a highly accurate measurement to characterize the frequency components of spectral features. When the optical frequency comb interacts with the tested medium, such as gas or particles, certain frequencies will be absorbed or scattered. Therefore, the spectral profile can be determined by comparing the gain or attenuation of these frequency lines. This technology has been widely used in chemical analysis, material science, and various fundamental study in chemistry and physics.

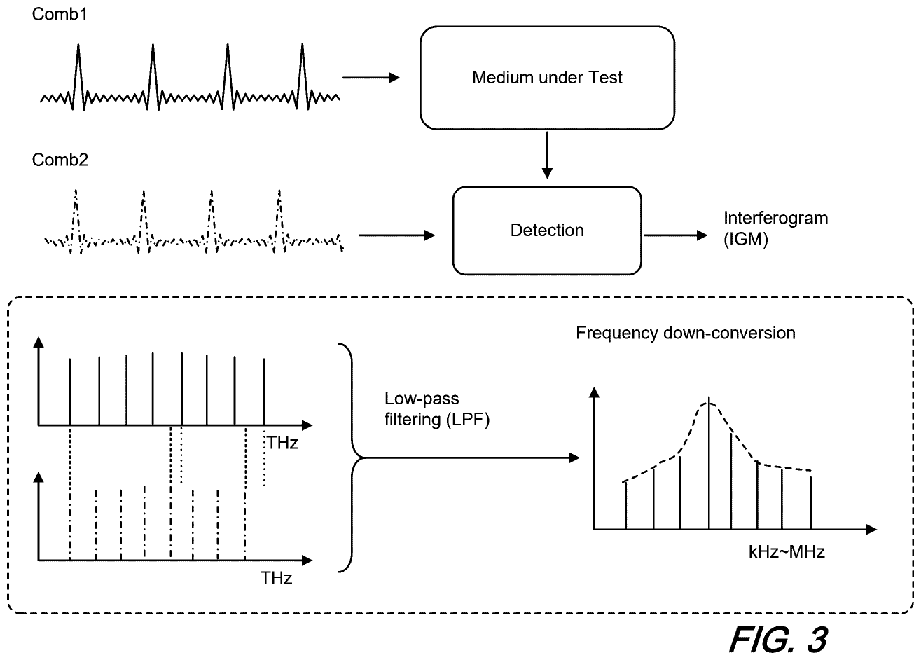

FIG. 3 is a schematic diagram showing illustrative dual-comb spectroscopy according to aspects of the present disclosure.

Those skilled in the art will know that dual-comb spectroscopy is a novel sensing technique which resolves several key limitations of frequency comb spectroscopy. As illustratively shown in FIG. 3, dual-comb spectroscopy utilizes two optical frequency combs, wherein the second comb has a slightly different spectral interval (in frequency domain) or pulse repetition rate (in time domain) from the first comb.

One comb (or both combs in some use cases) passes through the medium under test, and both combs are detected by a photo-receiver. The result appears a repeated series of interferometric signals in time domain, which is referred to interferogram (IGM). After low-pass filtering, the desired portion of the interferogram will be retained and analyzed,

The workflow of the dual-comb sensing technology, as shown in FIG. 1, including three stages: (i) the generation of two optical frequency combs; (ii) the detection of the dual-comb signals after interacting with the medium under test; and (iii) the signal processing stage to extract the desired information.

The first stage involves the generation of two high-quality optical frequency combs with slightly different frequency intervals. To ensure the high coherence of the two combs and to accurately adjust their frequency properties, typical method is to use electro-optic modulator to modulate the electrical waveforms on narrow-linewidth coherent light fields. The electrical waveforms can be generated from the digital instruments.

It is noted that many applications require a broad frequency comb bandwidth. Moreover, to ensure a sufficient low detection bandwidth, the frequency discrepancies between two combs should be small. Therefore, the digital instruments need a remarkably high bandwidth (or sampling rate) and an exceedingly long memory depth. Such instruments—such as high-end arbitrary waveform generators (AWGs)—are bulky and expensive scientific instruments that cannot be easily integrated for many practical applications.

Alternatively, the analog RF comb generators are promising solutions for practical applications and use cases, due to their low cost and compact dimension. There are a few literatures adopting the analog RF comb generators to create high-quality optical frequency combs for DCS. Prior art implementations have used a pair of step-recovery diodes (SRDs) to generate RF comb waveforms through intensity modulation (IM), as shown illustratively in FIG. 3.

The SRD is a type of analog broadband comb (harmonics) generator that operates in one of two states, which are determined by the presence or absence of a stored charge at the PN junction. One of the OFC was sent into the medium under test (i.e., optical fiber in this example) while the other OFC mixed with backscattering light in an optical coupler. The beating signal was detected with a balanced photodetector (BPD), as shown in FIG. 3. The IGM was filtered by a low-pass filter (LPF) which only keeps the 1^{st} Nyquist band

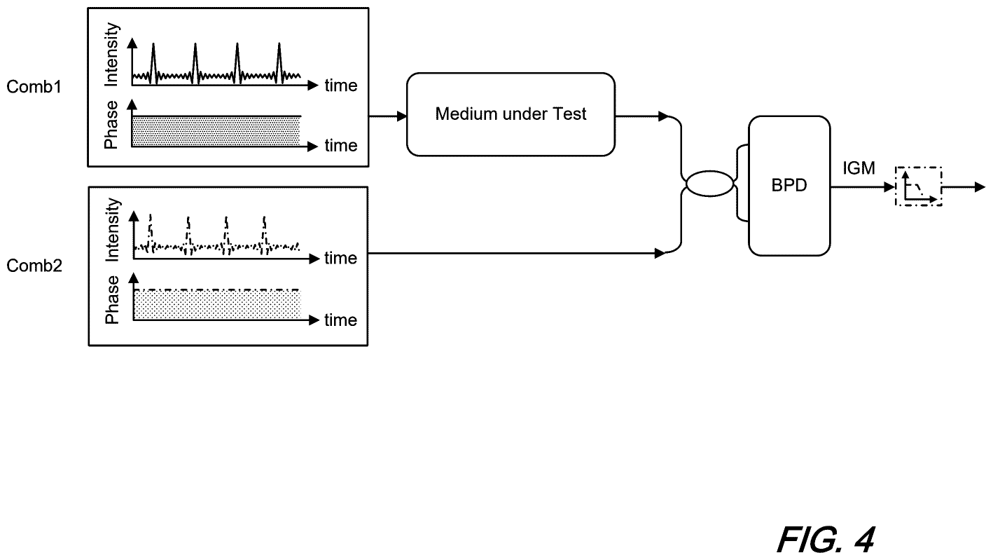

FIG. 4 is a schematic diagram showing an illustrative dual comb sensing scheme based on intensity modulation (IM scheme) according to aspects of the present invention.

Other researchers have reported the DCS by modulating the SRD outputs via the phase modulation (PM). In such the scheme, both the OFCs were generated by the PM with two SRDs. One of the OFCs was sent into the medium under test (i.e., gas in this example) while the other OFC mixed with the transmitted light in an optical coupler. The detection scheme was similar to that previously noted, while phase-locking feedback loop was used to improve the robustness but also increase the system complexity.

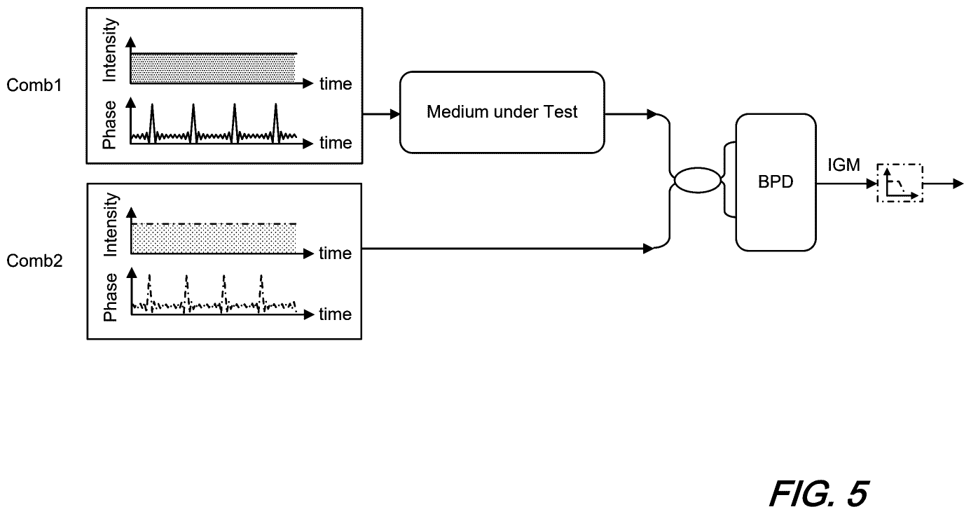

FIG. 5 is a schematic diagram showing an illustrative dual comb sensing scheme based on phase modulation (PM scheme) according to aspects of the present disclosure.

Although both the IM scheme and PM scheme have shown the feasibility of dual-comb sensing, there are several fundamental limitations.

First, in the IM scheme, the intensity of the light field is the same as the electrical waveforms from the analog comb generators, which are nearly transform limited, meaning that most of the optical energy are concentrated within a noticeably short time periods, while the other parts in time domain are minimized. It is okay to be short pulses as the “probe” signal in some use cases, such as lidar and photoacoustic sensing. However, in the detection stage, both combs are short pulses that will post severe high peak IGMs, leading to several detrimental issues including the nonlinear impairments and the modulation efficiency. Moreover, the high peak power and short pulse duration pose significant challenges to the photo detectors including the high input peak power and low output powers after filtering the 1^{st} Nyquist band.

Second, in the PM scheme, since the intensity of both of the combs are continuous-wave, the dual-comb interaction only occurs on the optical phase, which is not as effective as in the IM scheme. In the detection stage, the photodetector have to deal with a strong, constant optical power, which will significantly increase the noises, including shot noise, thermal noise, and the amplification noise.

Third, both the IM and PM scheme are vulnerable to the perturbations including phase drift and polarization drift. Since both the IM scheme and the PM scheme utilize a photodetector or a balanced photodetector, any phase noise or polarization mismatch will degrade the output intensity. In the worse cases, there will be severe fading issues when the phase and/or polarization are completely mismatched. Therefore, it is difficult to achieve a stable dual-comb sensing performance, especially in long-term operations.

According to aspects of the present disclosure, we describe a new dual-comb sensing scheme to solve the issues and problems in the existing IM or PM dual-comb sensing schemes.

In the comb generation stage, as illustratively shown in FIG. 5, one OFC is intensity modulated by an analog RF comb generator, e.g., SRD, while the other OFC is phase-modulated by another analog RF comb generator with a slightly different frequency spacing. The intensity-modulated OFC, (in narrow-pulse shape) is used as the “probe” to interacts the medium under test, while the phase-modulated OFC (in continuous waves) serves as the “local oscillator” used in the detection stage. It is noted that for PM modulation there is no need for a bias controller. So, our scheme will be simpler than the IM scheme in the comb generation stage

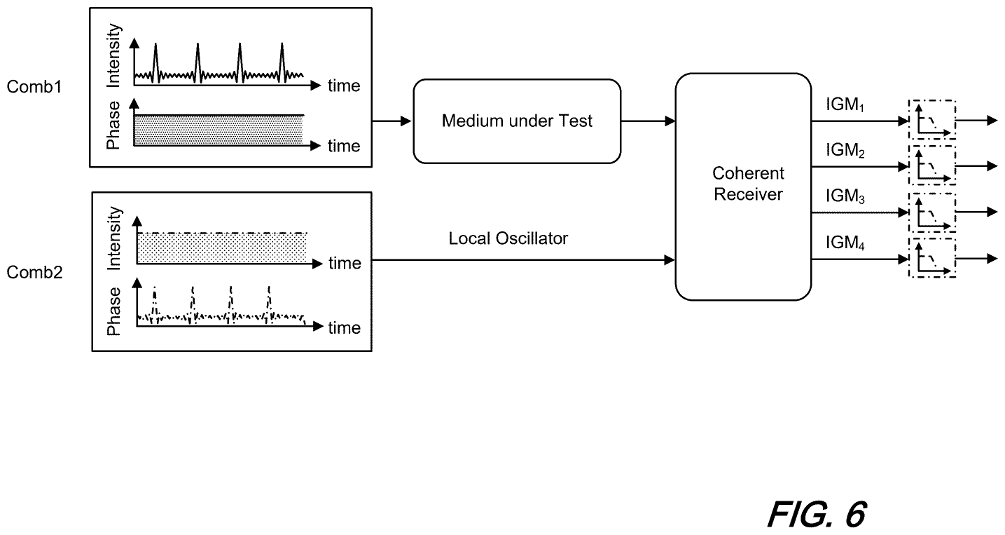

FIG. 6 is a schematic diagram showing an illustrative dual comb sensing scheme according to aspects of the present invention.

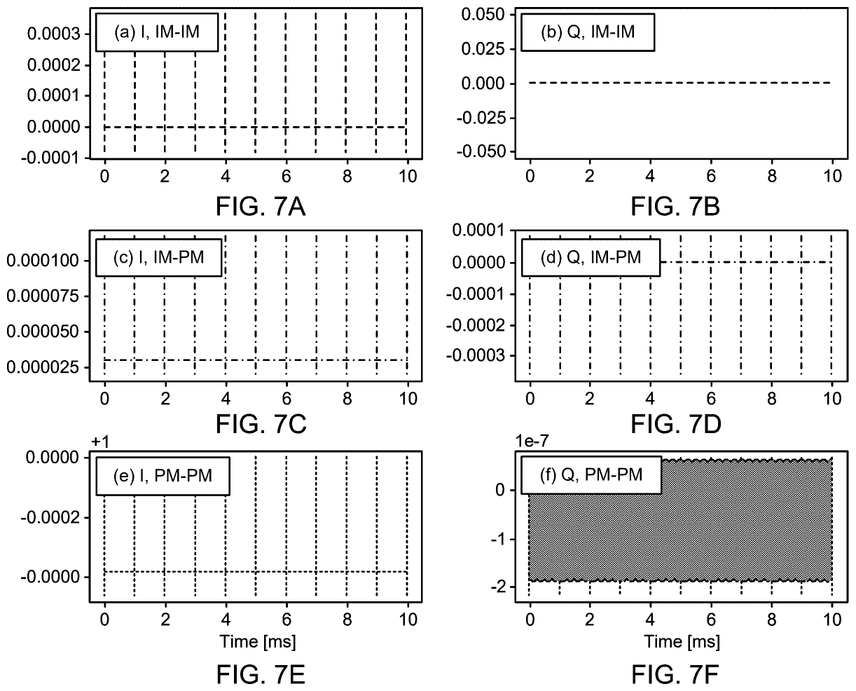

FIG. 7A, FIG. 7B, FIG. 7C, FIG. 7D, FIG. 7E, and FIG. 7F show a series of dual comb interferograms at 0 (rad) phase with 1^{st} Nyquist band LPF according to aspects of the present disclosure.

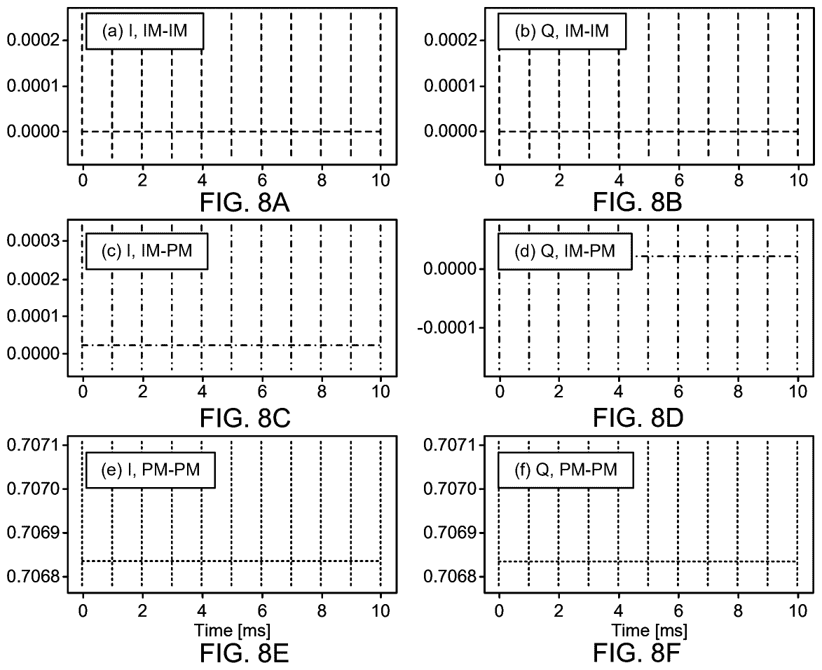

FIG. 8A, FIG. 8B, FIG. 8C, FIG. 8D, FIG. 8E, and FIG. 8F show a series of dual comb interferograms at π/4 phase with 1^{st} Nyquist band LPF according to aspects of the present disclosure.

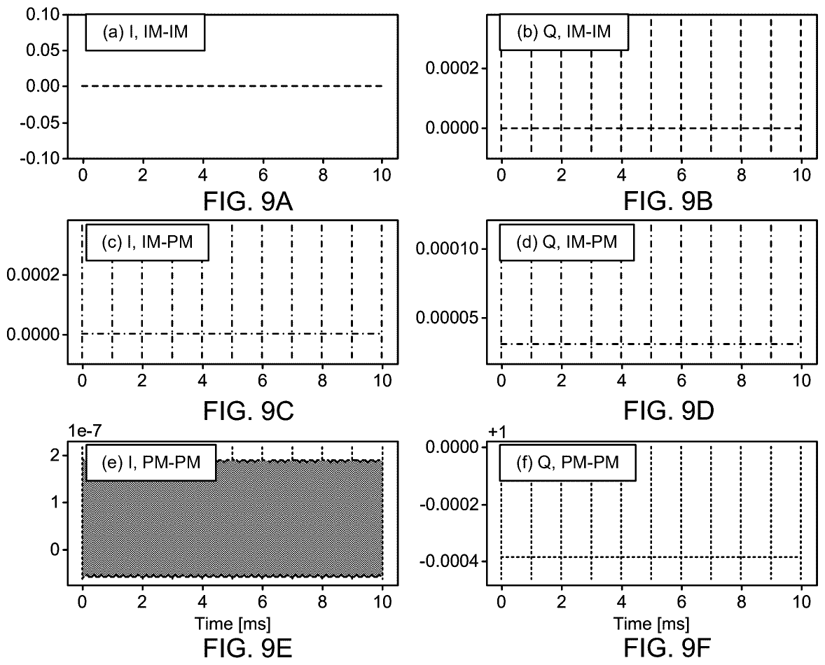

FIG. 9A, FIG. 9B, FIG. 9C, FIG. 9D, FIG. 9E, and FIG. 9F show a series of dual comb interferograms at π/2 phase with 1^{st} Nyquist band LPF according to aspects of the present disclosure.

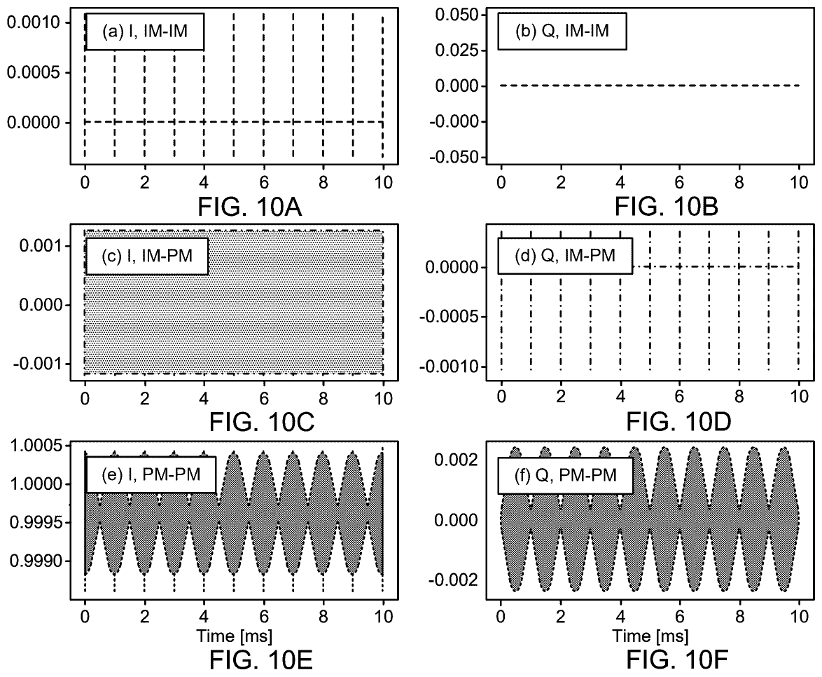

FIG. 10A, FIG. 10B, FIG. 10C, FIG. 10D, FIG. 10E, and FIG. 10F show a series of dual comb interferograms at 0 (rad) phase with 2^{nd} Nyquist band LPF according to aspects of the present disclosure.

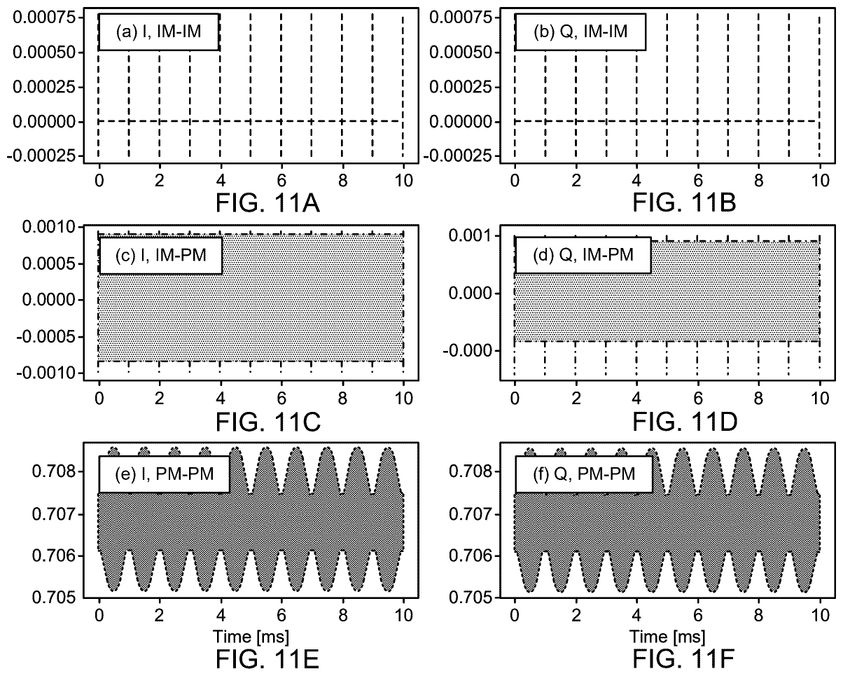

FIG. 11A, FIG. 11B, FIG. 11C, FIG. 11D, FIG. 11E, and FIG. 11F show a series of dual comb interferograms at π/4 phase with 2^{nd} Nyquist band LPF according to aspects of the present disclosure.

In the detection stage, our inventive scheme takes the advantage of the polarization diversity coherent detection. A coherent receiver will be used instead of the optical coupler. The IM comb is sent into the “signal” port of the coherent receiver, while the PM comb is used as the LO of the coherent receiver. Compared with the pulse-like IM comb, the CW PM comb has much more average optical power, therefore it will also function as the optical amplifier in the coherent receiver. Since the coherent receiver tackles both polarization and phase drift, the fading issues in the conventional scheme will be mitigated, while the detection efficiency will be enhanced.

In the signal processing stage, our inventive scheme has a flexible filtering strategy. Conventional schemes, including IM and PM schemes, only pick the 1^{st} Nyquist band while discarding all the other Nyquist bands. Such a method can enable a data acquisition at very low speed. However, it will also remove most of the signal powers, resulting in a low SNR which is difficult to detect. We notice that in many practical configurations, the acquisition bandwidth is not limited strictly. For example, prior art assertions that a sub-MHz acquisition bandwidth which only requires low-frequency electronics. However, to drive the SRDs, tens of MHz bandwidth DACs are still necessary. In fact, the electronics device that has tens of MHz bandwidth DACs may produce a broader ADC bandwidth. Thus, the restriction of acquisition bandwidth could be released in practice.

A unique feature of this inventive scheme is that, when the acquisition bandwidth is expanded and more Nyquist bands can be selected, our scheme can obtain more power compared with previous scheme, which can significantly increase the SNR and enhance the performance in the follow-up processing steps. The theoretical basis for this phenomenon, which is beyond the scope of this IR, is under investigation at this moment. But we have verified the results by conducting extensive studies.

FIGS. 6, 7A-7F, 8A-8F, 9A-9F, 10A-10F, and FIGS. 11A-11F show preliminary results. As an example, we consider a dual-comb sensing scheme generated from two transform-limited SRDs. The SRDs are driven by two sine waves of the frequency of 10 MHz and 10.0001 MHz, respectively. In the intensity modulation, the modulator is biased near null point to optimize the shape of the light wave, while in the phase modulation there is no bias applied. We consider a back-to-back configuration and utilize the coherent receiver to detect the dual-comb signals. Without loss of generality, we assume the polarization is aligned to the X-axis and the relative phase between two combs drifts. For different polarization states it can be easily derived from a Jones matrix rotation.

We evaluated the results at different relative phases, i.e., 0, π/4, and π/2. FIG. 6 shows the dual-comb IGMs at 0 (rad) phase with the 1^{st} Nyquist band low-pass filtering (conventional method). The red lines are the IGMs of the in-phase (I) and quadrature (Q) of the IM scheme (denoted as IM-IM). The green lines are the IGMs of the PM scheme (denoted as PM-PM). The blue lines are the IGMs of our proposed scheme (denoted as IM-PM). FIG. 6 shows that when the phase difference is zero rad, both IM scheme and the PM scheme only have the in-phase components, while the quadrature components are zero. However, in our scheme, both the I and Q are visible, while the Q is around ten times larger than the I component

FIGS. 7A-7F and FIGS. 8A-8F illustrate results when the phase difference between two combs are π/4 and π/2, respectively. When the phase is π/4, the IM scheme and our scheme has similar performance, while there is extraordinarily strong DC components in the PM scheme. When the phase is π/2, the results are like that case of zero rad phase with the exchange of I and Q components.

We then change the filtering strategy which includes the 2^{nd} Nyquist bands in the low-pass filtering step. FIGS. 9A-9F and FIGS. 11A-11F show the results with 2^{nd} Nyquist band LPF. When phase difference is zero rad, The I component of IM scheme and the Q component of our scheme has similar amplitude. While the Q of IM scheme is still near zero, the I of our scheme is boosted near ten times compared with the 1^{st} Nyquist band filtering strategy. The Q of PM scheme has a higher magnitude, while the I component comes with an extraordinarily strong DC part that will post strong noises in the detection

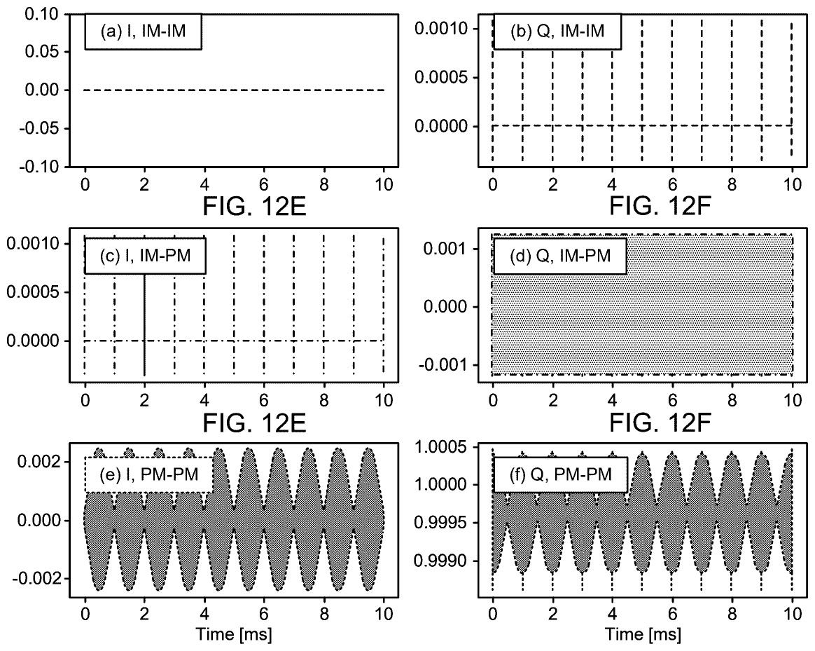

FIGS. 12A-12F illustrate the results with the phase difference is π/4 with 2^{nd} Nyquist LPF. The peak-to-peak magnitude of our scheme is almost two times the IM scheme. It is also clear that our scheme has more power distributed in the time domain (i.e., more signal powers) compared to the IM scheme. In FIG. 11 which the phase difference is π/2, we found the results are similar to the case of zero rad phase with the exchange of I and Q components

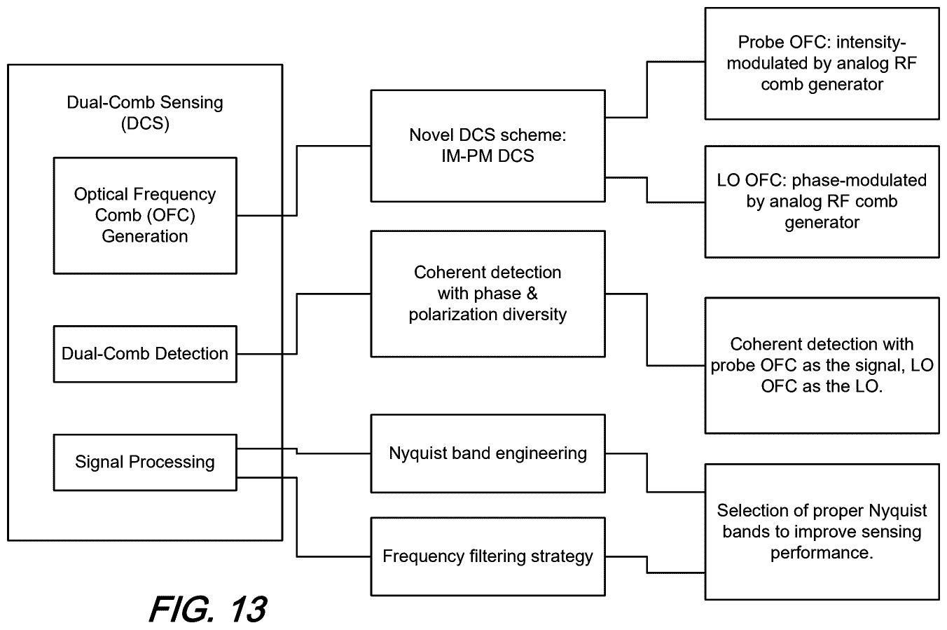

FIG. 13 is a schematic diagram in hierarchical format showing illustrative features of systems and methods according to aspects of the present disclosure.

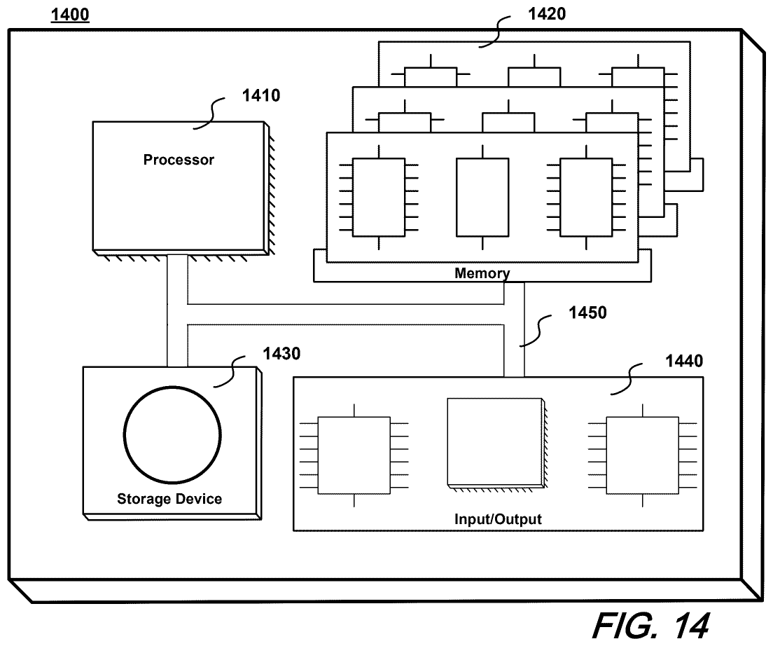

FIG. 14 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1400 as stored program control instructions.

Computer system 1400 includes processor 1410, memory 1420, storage device 1430, and input/output structure 1440. One or more input/output devices may include a display 1445. One or more busses 1450 typically interconnect the components, 1410, 1420, 1430, and 1440. Processor 1410 may be a single or multi core. Additionally, the system may include accelerators etc., further comprising the system on a chip.

Processor 1410 executes instructions in which embodiments of the present disclosure may comprise steps described in one or more of the Drawing figures. Such instructions may be stored in memory 1420 or storage device 1430. Data and/or information may be received and output using one or more input/output devices.

Memory 1420 may store data and may be a computer-readable medium, such as volatile or non-volatile memory. Storage device 1430 may provide storage for system 1400 including for example, the previously described methods. In various aspects, storage device 1430 may be a flash memory device, a disk drive, an optical disk device, or a tape device employing magnetic, optical, or other recording technologies.

Input/output structures 1440 may provide input/output operations for system 1400.

While we have presented our inventive concepts and description using specific examples, our invention is not so limited. Accordingly, the scope of our invention should be considered in view of the following claims.

1. A dual comb sensing method comprising:
dual comb generation,
dual comb detection, and
signal processing,
THE METHOD CHARACTERIZED IN THAT:
in the dual comb generation, a first optical frequency comb (OFC) is intensity modulated by an analog radio frequency (RF) comb generator while a second OFC is phase-modulated by another analog RF comb generator.

2. The method of claim 1 FURTHER CHARACTERIZED IN THAT:
In the dual comb detection, detection of two optical frequency combs is performed using a coherent receiver with phase diversity and/or polarization diversity.

3. The method of claim 2 FURTHER CHARACTERIZED IN THAT:
In the dual comb detection, the intensity modulated OFC is used as a probe while the phase modulated OFC serves as a local oscillator.

4. The method of claim 3 wherein the phase difference between the two combs are π/4 and π/2, respectively.

5. The method of claim 4 wherein the intensity modulated OFC is modulated by an RF comb generator selected from the group consisting of: step recovery diode (SRD) and nonlinear transmission lines (NLTLs).
